(19) United States
(12) Patent Application Publication
(10) Pub. No.: US 2007/0055955 A1
(43) Pub. Date: Mar. 8, 2007

(54) System and method for information handling system display color space management

(76) Inventors: Jae Ik Lee, Round Rock, TX (US); Stefan Peana, Austin, TX (US)

Correspondence Address: HAMILTON & TERRILE, LLP, P.O. BOX 203518, AUSTIN, TX, 78720, US

(21) Appl. No.: 11/211,059

(22) Filed: Aug. 24, 2005

(51) Int. Cl. G06F 9/44

(52) U.S. Cl. 717/113; 717/100

(57) ABSTRACT

An information handling system display presents multimedia visual information with plural performance settings based on the type of image associated with the visual information. For instance, an image detector detects plural types of images so that a display controller automatically applies color and brightness settings associated with the type of detected image. Flash memory stores the sets of performance settings for use by the display controller as different types of images are detected, such as movie images, picture images, game images and text images.

### BACKGROUND OF THE INVENTION

1. Field of the Invention

The present invention relates in general to the field of information handling system displays, and more particularly to a system and method for information handling system display color space management.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Over the past several years, information handling system and conventional entertainment system technologies have converged to use common hardware and standards for presentation of audio and visual information. One prominent example of this convergence is the growing use of high definition television signals or HDTV. High resolution images are communicated as compressed digital information for presentation on flat panel LCD or plasma displays. Flat Panel HDTVs typically have specialized hardware and software components that provide high quality images, such as moving images, with the quality of the presented images generally corresponding to the cost of components used to build the system. However, consumers have come to expect that flat panel displays will present high quality images with high resolution, vivid colors, high brightness and increased contrast, regardless of the type of system or components.

Consumer expectations for high quality multimedia entertainment images are often disappointed for flat panel displays that are associated with or integrated into information handling systems. Unlike HDTV systems, information handling systems have to adjust to a variety of uses, not just the display of multimedia entertainment, and a variety of environments. For example, portable information handling systems sometimes operate only on internal power and thus present images with reduced brightness and processing components throttled to reduced speeds. Information handling systems primarily present text from applications, such as browsers, e-mail or word processing, that do not have the varying demands on brightness, contrast or color more common in entertainment images. HDTVs typically have specialized hardware and/or visual interfaces to accept user settings for adjustments to visual quality, such as brightness, contrast and color. In contrast, information handling system displays typically only accept brightness adjustments in defined “nit” steps and sometimes adjust brightness automatically for changes in ambient lighting with ambient light sensors (ALS). If color adjustments are supported by an information handling system display, an average default mix is generally set unless manually set by a user. With portable information handling systems, adjustments to brightness and, when supported, to color are typically made through a BIOS interface with manual inputs, such as with selection of control and F8 inputs that are not user friendly.

### SUMMARY OF THE INVENTION

Therefore a need has arisen for a system and method which adjusts information handling system display settings for presenting different types of images.

In accordance with the present invention, a system and method are provided which substantially reduce the disadvantages and problems associated with previous methods and systems for determining information handling system display settings. Display performance settings are selected to present visual information as an image at the display based on the type of image presented.

More specifically, an image detector determines the type of image to be presented by a display and provides a controller with performance settings to use in the presentation of the image. For instance, visual information is analyzed to detect movie, picture, game or text images and, based on the type of image detected, color and brightness performance settings are retrieved from flash memory and applied to display the image. Other types of performance settings may also be automatically retrieved and applied, such as brightness adjustments in response to ambient light sensing, volume adjustments for speakers to play audio information associated with the image, or the response time of pixels in performing color adjustments. Performance settings associated with an image type are automatically applied without user input based on detection of that image type so that display performance is optimized in a manner transparent to the user.

The present invention provides a number of important technical advantages. One example of an important technical advantage is that an information handling system display quickly an automatically adjusts performance settings based on the image type or content presented by the display, therefore providing optimal display under diverse conditions. User expectations for high quality multimedia entertainment presentations at portable information handling system displays are met without impacting performance constraints associated with presentation of other types of information. Automated selection of performance settings reduces the need for user interactions with information handling system BIOS interfaces to simplify optimized presentation of different types of information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a portable information handling system having dynamic display performance settings automatically selected for plural types of presented images;

FIG. 2 depicts a graph of one example of color setting space for plural types of images;

FIG. 3 depicts a graph of one example of brightness settings for plural types of images; and

FIG. 4 depicts a graph of one example of ambient light sensor settings of plural types of images.

### DETAILED DESCRIPTION

Presentation of visual information as images at an information handling system display is managed by automatically configuring the display with performance settings associated with the type of image presented at the display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

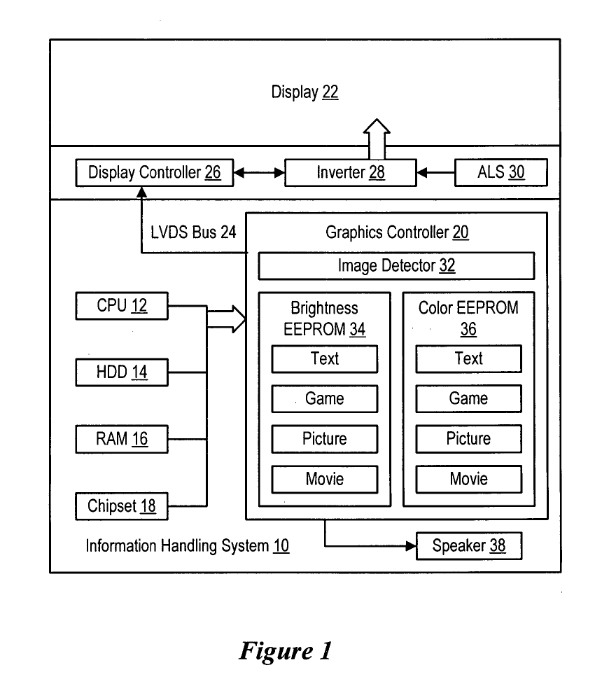

Referring now to FIG. 1, a block diagram depicts a portable information handling system 10 having dynamic display performance settings automatically selected for plural types of presented images. Information handling system 10 has processing components to generate audiovisual information for presentation to a user, such as a CPU 12, hard disk drive 14, random access memory 16, chipset 18 and a graphics controller 20. The audiovisual information is communicated to a graphics controller 20, which formats the visual information for display as an image and communicates the visual information to a display 22 over a LVDS bus 24. Display 22 has a controller 26 that receives the formatted visual information from graphics controller 20 and manages presentation of the image through pixels of display 22. For instance, display controller 26 manages the output of inverter 28 to control the brightness of a backlight that illuminates the pixels. An ambient light sensor 30 interfaced with inverter 28 detects the level of ambient light to adjust the brightness output by inverter 28. Although display controller 26 is depicted as separate from graphics controller 20, in various embodiments the functions of display controller 26 are distributed between various hardware, firmware and software modules, such as in microcontrollers within display 22 and inverter 28 or firmware instructions in graphics controller 20 or other components, like an embedded controller located within chipset 18.

Graphics controller 20 includes an image detector 32 that monitors visual information sent for presentation at display 22 to determine if the image generated by the visual information is one of plural types of predetermined images. For instance, presentation of an image from an MPEG file classifies the image as a movie type, presentation of an image from a JPEG file classifies the image as a picture type, presentation of an image from a game application classifies the image as a game type, and presentation of an image from a word processing, browser or e-mail application classifies the image as a text type. Based upon the image type determination, image detector 32 retrieves performance settings for the presentation of the image and provides the performance settings to display controller 26 for application at display 22. For instance, if a movie type image is detected, image detector 32 retrieves brightness and color performance settings from brightness EEPROM 34 and color EEPROM 36, and communicates the color brightness settings to display controller 26, which automatically applies the settings for presentation of the image. In alternative embodiments, the performance settings are stored in flash memory collocated with display controller 26 or located at other physical locations accessible by display controller 26 or graphics controller 32. For instance, EEPROM included in display 22 can store performance settings directly accessible by display controller 26 and accessible to graphics controller 20 through serial communication over LVDS bus 24. Other types of performance settings may also be included, such as settings that manage the corrections made by ambient light sensor 30 for varying degrees of detected ambient light, or the response time of display 22. More rapid response times aid the clarity of a movie image but add little to the presentation of still images. Another example of a performance setting is the speaker volume for playing audio information associated with detected image types from a speaker 38.

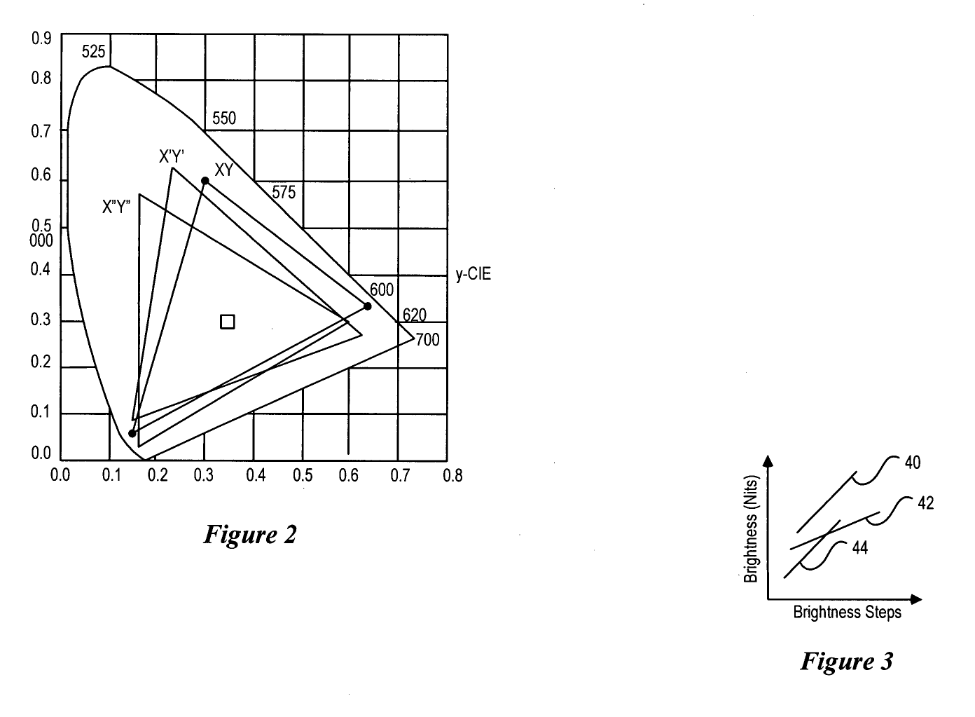

Referring now to FIGS. 2, 3 and 4, different sets of display performance settings are graphically depicted with association to various types of image types. FIG. 2 depicts color space performance settings for use with movie, picture and text image types. The triangle-shaped lines marked XY represent adjustments made to colors of a movie image, lines X′Y′ represent adjustments made to colors of a picture image, and lines X″Y″ represent adjustments made to colors of a text image. The value for each pixel color is re-calculated with the RGB coordinates of FIG. 2 based on the type of image displayed at the pixel. The selection of a color space automatically induces selection of a brightness curve associated with the color space as depicted by FIG. 3. Line 40 depicts the brightness applied for movie images, line 42 depicts the brightness applied for picture images, and line 44 depicts the brightness applied for text images. A user selected brightness step has a nit value for illumination based on the type of image as depicted by the following table:

| Brightness | Text/Web | Picture | TV/Movie | Custom |
|---|---|---|---|---|
| Step | Mode | Mode | Mode | Mode |
| 1 | 10 | 20 | 120 | |
| 2 | 17 | 40 | 140 | |
| 3 | 24 | 60 | 160 | |
| 4 (Default) | 30 | 60 | 180 | |
| 5 | 60 | 120 | 200 | |
| 6 | 110 | 160 | 240 | |
| 7 | 150 | 200 | 280 | |
| 8 | 220 | 240 | Max | |

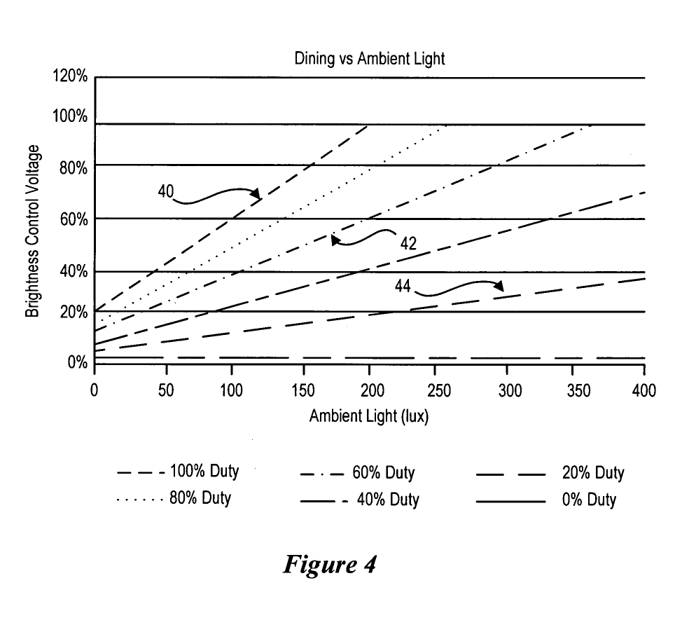

Thus, for instance, with brightness set at step 3 a performance setting of 24 nits is used to illuminate text images and 160 nits is used to illuminate a movie image. The custom mode settings are available for a user to input desired settings for custom situations, such as initiation of a predetermined application or presentation of particular images. The alterations to the brightness imposed by ambient light sensing is adjusted in accordance with the curves illustrated in FIG. 4 so that movie image types have less dimming imposed by ambient light sensing with line 40 while pictures and text have a greater impact as depicted by lines 42 and 44 respectively. In one embodiment, a user may select performance settings for certain image types in a custom manner through the operating system or BIOS.

In operation, image detector 32 monitors the information presented at display 22 to determine if a type of image is presented that differs from the image associated with the current performance settings. For instance, if text mode performance settings are used by graphics controller 20 or display controller 26, then image detector 32 monitors for movie, picture or gaming images. Once image detector 32 detects a new type of image, then a determination is made of whether to reset the performance settings to those associated with the new type of image. In one embodiment, a message is presented to the user asking whether to change performance settings. For example, if a user plays a movie that the user received in an e-mail attachment with a window having a size of less than the display screen, then user may decide to stay in the text mode to reduce disruption of the e-mail presentation or may decide to enter the movie mode for the entire display screen. The message provides the user with the option of saving entry into multimedia mode or remaining in text mode as a preference that applies automatically during subsequent presentations of similar split screen displays. Entry into the multimedia mode is performed by retrieving the movie performance settings, such as brightness and color settings, and applying the settings to display 22, such as at the display controller 26 or graphics controller 20 as appropriate. Image detector 32 then monitors for a change of the information presented at the display from the movie mode to a different type of mode, such as back to the text mode if the user closes the movie attachment. The user may directly control the transition between display modes and the performance settings of a particular mode by interfacing with image detector 32, such as through the chipset 18 or a BIOS running on chipset 18 or graphics controller 20.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to generate visual information for presentation at a display;
a display operable to accept the visual information and present the visual information as an image having brightness and color;
a controller interfaced with the processing components and the display, the controller operable to manage performance settings of the display; and
an image detector interfaced with the controller, the image detector operable to determine if the visual information is associated with a one of plural image types, the image detector and controller cooperating to apply performance settings for presenting the determined image type.

2. The information handling system of claim 1 wherein the plural image types comprise a text image and a movie image.

3. The information handling system of claim 1 wherein the plural image types comprise a text image and a picture image.

4. The information handling system of claim 1 wherein the plural image types comprise a text image and a game image.

5. The information handling system of claim 1 wherein the performance settings comprise color settings.

6. The information handling system of claim 1 wherein the performance settings comprise brightness settings.

7. The information handling system of claim 1 further comprising a speaker operable to play audio information associated with the visual information and wherein the performance settings comprise speaker volume.

8. The information handling system of claim 1 further comprising an ambient light sensor operable to automatically adjust display brightness in response to ambient light, the performance settings comprising ambient light adjustments.

9. The information handling system of claim 1 further comprising:
flash memory interfaced with the controller; and
plural brightness performance settings and plural color performance settings stored in the flash memory, the controller applying a brightness setting and a color setting for each image type.

10. A method for presenting visual information as an image at an information handling system display, the method comprising:
monitoring the visual information to detect plural types of images;
detecting one of the plural types of images;
retrieving plural performance settings for the detected type of image; and
automatically applying the performance settings to the display to present the visual information.

11. The method of claim 10 wherein the performance settings comprise brightness and color settings.

12. The method of claim 11 wherein the image type comprises a movie.

13. The method of claim 11 wherein the image type comprises a picture.

14. The method of claim 11 wherein the image type comprises a game.

15. The method of claim 11 wherein the image type comprises text.

16. The method of claim 11 wherein the visual information is associated with audio information and the performance settings comprise speaker volume to play the audio information.

17. The method of claim 11 wherein the performance settings comprise ambient light sensor brightness adjustments for detected ambient light.

18. A system for managing the presentation of visual information as images at an information handling system display, the system comprising:
a display controller operable to apply color and brightness settings to the display;
an image detector operable to detect visual information associated with plural types of images;
plural sets of brightness settings, each set associated with one of the plural types of images; and
plural sets of color settings, each set associated with one of the plural types of images;
wherein the display controller is further operable to automatically apply the set of color and brightness settings associated with the type of image detected by the image detector.

19. The system of claim 18 wherein a detected image type has associated audio information, the display controller further operable to automatically apply speaker settings to a speaker for playing the audio information.

20. The system of claim 18 further comprising plural sets of ambient light settings, each set associated with one of the plural types of images, the display controller further operable to automatically apply the set of ambient light settings associated with the type of image detected by the image detector.
